(19) United States
(12) Patent Application Publication
(10) Pub. No.: US 2006/0237333 A1
(43) Pub. Date: Oct. 26, 2006

(54) Method for the detection of carbon monoxide in a hydrogen-rich gas stream

(76) Inventor: Willem Gilles Planje, Alkmaar (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 10/544,566

(22) PCT Filed: Feb. 6, 2004
(86) PCT No.: PCT/NL04/00084

§ 371 Date: May 1, 2006

(30) Foreign Application Priority Data
Feb. 6, 2003 (NL) 1022603

(51) Int. Cl. G01F 1/64; G01N 27/26

(52) U.S. Cl. 205/782; 204/431

(57) ABSTRACT

In a method and device for the detection of CO in a hydrogen-rich gas stream, detection takes place with the aid of a miniature electrochemical cell and is based on the principle that carbon monoxide that moves past the anode screens the anode material, as a result of which the reaction with hydrogen at the anode is impeded. By determining the decrease in the current density it is possible to determine the degree of screening as a function of time and thus the percentage CO. According to the invention the gas is fed past the anode only and the cathode is in direct contact with a water bath.

The present invention relates to a method for the detection of CO in a: hydrogen-rich gas stream, comprising feeding said gas stream past an electrochemical sensor, measurement of the current density through said electrochemical cell at a potential for the sensor electrode applied such that no oxidation of CO will take place, whilst oxidation of hydrogen is possible, resulting in the electric current in said electric cell, and determination therefrom of the CO concentration, the hydrogen-rich gas stream being fed past the anode of said sensor and the cathode of said sensor being wetted with water.

Such a method is generally known in the art. By way of example, reference is made to U.S. Pat. No. 4,820,386.

The measurement of CO in a gas stream containing hydrogen is important when using fuel cells where CO is an undesired component. For large stationary installations, infrared measurements can be used, but such infrared measurements are too complex for small and in particular mobile installations.

Therefore it has been proposed in the prior art to measure CO using a small electrochemical cell. In the case of air and other gas streams where CO can mainly be oxidised, carbon monoxide is detected by feeding carbon monoxide past an anode and oxidising it at the latter. The oxidation stream to be measured is a measure for the CO concentration. With such a method a relatively high electrode voltage is applied in order to be able to oxidise CO. This voltage is dependent on the electrode material and the environment in question. A voltage of>600 mV above the potential of the normal hydrogen electrode (NHE) is mentioned as a typical value. Examples thereof are described in U.S. Pat. No. 5,650,054 and EP 1 154 267 A2. However, such a method is unsuitable in a hydrogen-rich environment such as is present in fuel cell installations where hydrogen-rich gas is a promising energy carrier.

The hydrogen-rich gas is fed past the anode of a measurement cell. During this procedure carbon monoxide screens part of the anode catalyst and the yield of the cell for oxidation of hydrogen will decrease.

According to a first embodiment it is possible to measure the equilibrium value of the current density that is established. However, this method is time-consuming.

Another method is to measure the decrease in the current density by screening the anode with carbon monoxide.

After some time the CO is removed therefrom by increasing the potential on the anode and a new measurement cycle can start.

With this method, a relatively low potential is used at the sensor electrode to prevent oxidation of CO taking place. Of course, oxidation of hydrogen remains possible.

With the method described above for the measurement of CO in a hydrogen-rich environment the measurement gas is fed past both the anode and the cathode. In order to obtain an accurate measurement it is essential that the pressure of the gas is accurately controlled or is well known. The same applies in respect of the temperature of the cell. Another important factor is the relative humidity of the gas.

This humidity is important because the membrane must have a constant proton-conducting capacity. If there is no proton-conducting capacity, the measurement result is inaccurate. It has been found that at a measurement cell temperature that is higher than the dew point of the gas insufficient moisture is present to achieve an accurate measurement.

In the state of the art the gas is pre-wetted before exposing it to the measurement cell. Such a method is complex and introduces additional buffer volumes between the source and the measurement cell with a slow sensor response as a result.

The aim of the present invention is to provide a method for the detection of carbon monoxide in a hydrogen-rich gas stream.

This aim is achieved in the method described above in that the hydrogen-rich gas stream is fed only past said anode and said cathode is placed in a water bath.

According to the present invention the gas stream to be measured is no longer fed past both anode and cathode but only past the anode. The cathode is kept constantly wet by water added thereto. This water diffuses through the membrane so that, in principle, no wetting of the gas stream to be measured effected prior to the measurement is necessary. The method described above is suitable both for the method involving measurement of CO in a hydrogen-rich gas stream, where the current is measured until an equilibrium is established in the electrochemical cell, and for the method where the change in current density is a measure for the CO concentration.

Apart from the use described above in combination with fuel cells and more particularly PEM fuel cells where reforming of carbon-containing fuels takes place, the present invention can be used as a measurement cell in industrial reforming processes where hydrogen and carbon monoxide are formed.

According to the present invention it is no longer necessary to use a separate CO-tolerant catalyst such as Pt/Ru for the cathode material. Platinum on its own, the material that is also used for the anode, suffices, whilst other less expensive materials can also be used.

The abovementioned relatively low voltage, as a result of which no oxidation of CO takes place, is dependent on the electrode material used, the environment used and the temperature. This voltage is typically below 600 mV compared with NHE, but above the normal hydrogen electrode voltage. More particularly, a typical value is less than 350 mV. This latter value applies for a platinum/carbon electrode which is exposed to an H₂SO₄ solution. A person skilled in the art can determine the relevant threshold value depending on the environment used and the electrode.

Supply of water to the cathode can take place in a particularly simple manner in that the electrochemical cell is placed in a container and the cathode forms the bottom of a water reservoir and thus is in direct contact with the water (liquid). It is, however, also possible to feed the water via a separate line. In this case a system with only two electrodes is preferably used.

The present invention also relates to a device for the detection of CO in a hydrogen-rich gas stream, comprising an electrochemical cell with anode, plastic membrane and cathode, provided with an inlet for gas and an outlet for gas as well as control means connected to said anode and cathode and designed to remove CO from the anode, wherein said gas inlet and gas outlet are connected to said anode only and wherein said cathode is provided with a water supply.

According to a particular variant especially suitable for dry gas, the membrane/electrodes system is provided not only with a measurement zone but also with a wetting zone. The anode and cathode catalyst are arranged in the measurement zone. This measurement zone is downstream of the wetting zone, which serves mainly to introduce moisture originating from the cathode into the gas to be measured. In order to be certain that this moisture is actually also taken up by the gas, according to an advantageous embodiment the path for the gas to be measured is delimited from a component, such as, for example, a current collector, on the anode side.

The invention will be explained in more detail below with reference to an illustrative embodiment shown in the drawing.

In the drawing:

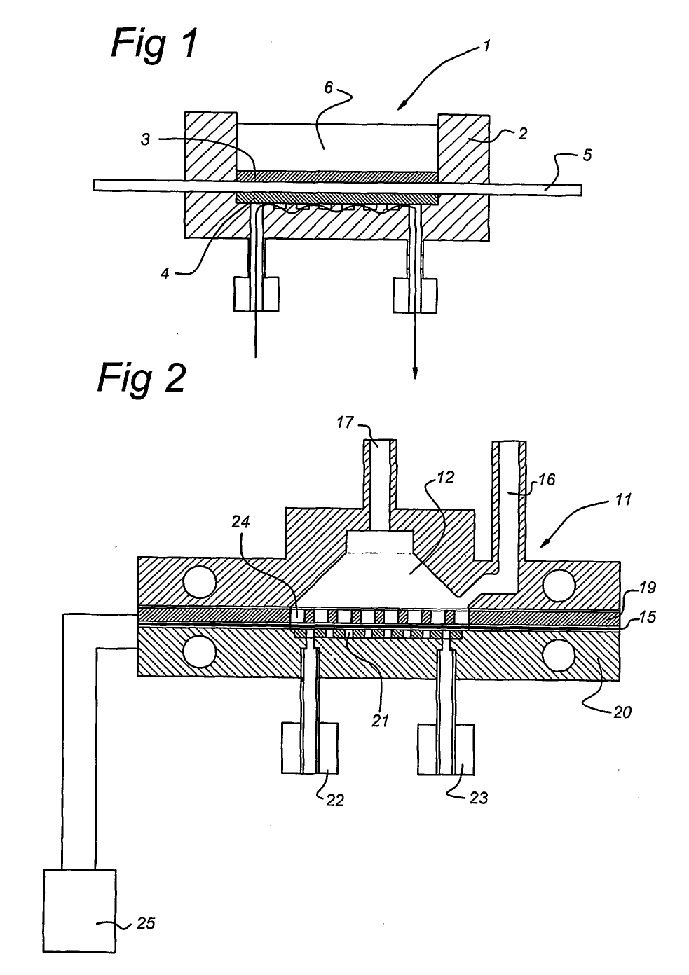

FIG. 1 shows, diagrammatically, the principle according to the present invention,

FIG. 2 shows, in cross-section, the embodiment of the measurement cell according to the invention;

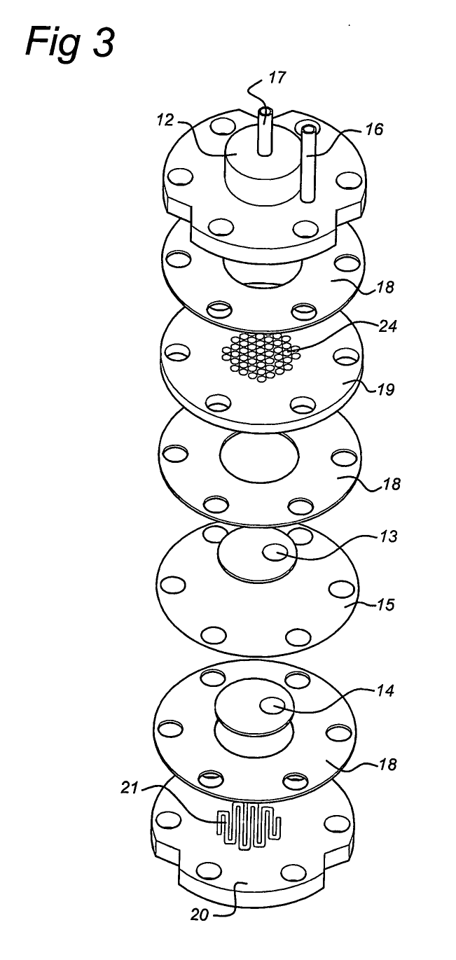

FIG. 3 shows an exposed view of the various components of the device according to FIG. 2, and

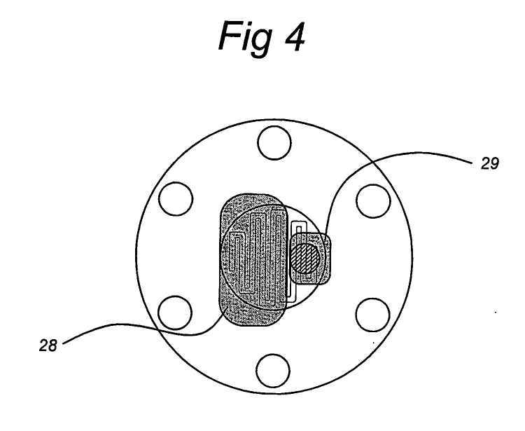

FIG. 4 shows, diagrammatically, a plan and partially exposed view of part of a wetting/measurement zone.

The measurement principle according to the present invention is shown in FIG. 1. An electrochemical cell 1 comprises a container 2 in which a cathode 3 and anode 4 are accommodated. A gas stream that is indicated diagrammatically by the arrow and essentially consists of hydrogen in which the CO to be measured is present moves past the anode. On the cathode side a water bath is indicated by 6.

As a result of the presence of the water bath 6, it can be guaranteed that the membrane (for example Nafion) is always adequately wetted via the cathode 3. A control device is connected to the cathode and anode in a manner that is not shown. According to a particular variant of the invention, during the measurement a measurement voltage of 10-400 mV, and more particularly approximately 350 mV, is applied between the anode and cathode, with the result that hydrogen is oxidised at the anode and protons are regenerated to hydrogen at the cathode. The change in the current density caused by carbon monoxide that covers the anode, is a measure for the amount of carbon monoxide in the gas. By applying an increased potential difference of 600 mV-1.0 V the cell can be regenerated as a consequence of the oxidation of CO to CO₂, as a result of which the covering is cancelled out. Depending on the temperature and pressure as well as the rate with which the current density is sampled, up to more than 1000 ppm CO can be detected. If there is inadequate moisture in the measurement cell and more particularly in the membrane, measurement inaccuracies are produced. With the construction as shown in FIG. 1, it is always guaranteed that adequate moisture is present.

The construction shown here is preferably installed in a feed line for hydrogen-rich gas for any application. In general, this line will be constructed as a bypass line because only small volumes are sufficient to achieve an accurate measurement and the supply of water via the cathode remains restricted. A value of 20-100 ml gas under standard conditions per minute is mentioned as an example.

Of course, provisions must be made to discharge the hydrogen that is produced on the cathode side. However, it is possible to discharge both this hydrogen and this relatively small gas stream that is tapped off from a main stream for this measurement into the environment or to feed these back into the main stream.

Both the cathode and anode are preferably made of a platinum material. A rapid and accurate measurement can be obtained by use of a low platinum loading on the anode. For example 5 μg platinum per cm² is used for the anode. As a result of the use of a high platinum loading on the cathode side, the cathode functions not only as a good counter-electrode but also as a good reference electrode. For example, 5 mg Pt per cm² is used on the cathode side. The platinum can be applied to the electrode concerned in any manner known in the art.

A practical embodiment of the invention is shown in FIGS. 2-4. An electrochemical cell is indicated by 11. 12 is a water reservoir, whilst 13 (see FIG. 3) is the cathode. The anode is indicated by 14 and this is surrounded by a diffusion layer. Cathode and anode are separated by a membrane 15 made of proton-conducting polymer material such as Nafion. Current collectors are shown by 19 and 20. Current collector 19 is provided with openings 24, whilst the current collector 20 is preferably provided with a serpentine-like channel 21. A controller that is connected to the current collectors 19, 20 is indicated by 25, whilst 22 is the gas inlet for the gas to be measured and 23 the outlet for the gas to be measured. The water feed is indicated by 16 and the gas (hydrogen) discharge by 17. There are various seals 18 to make the cell liquid-/gastight.

The device described with reference to FIG. 2-4 functions as follows. Gas enters via inlet 22 and is forced to move through channel 21 past anode 14. On moving through the channel 21 the hydrogen-rich gas to be measured passes into zone 28 (FIG. 4), where it is wetted. Wetting takes place via water that is present in container 12 through line 16 and diffuses through the membrane 15 via the openings 24 in current collector 19. The gas that moves past the membrane and has been wetted passes into zone 29 where it is fed past the anode 14. Carbon monoxide covers the active anode. After some time has elapsed an equilibrium situation is produced and the current density in this equilibrium situation is a measure for the CO concentration. Another method for determining CO is measurement of the changes that occur in the current density. After some time regeneration can take place by arranging for the application of an increased potential over the current collectors 20 and 19 by the measurement device 25.

Although the invention has been described above with reference to a preferred embodiment, it will be understood that numerous modifications can be made without going beyond the scope of the present application. The cell according to the present invention has a wide variety of applications for the measurement of gas streams in which CO is present as well as a further gas that is oxidised sooner by an electrochemical cell. The cell also has applications for gas streams in which a catalyst-screening component other than CO is present as well as a further gas that is oxidised sooner by an electrochemical cell than is the catalyst-screening component, provided this catalyst-screening component can also be oxidised again at higher potential. Such modifications are considered to fall within the scope of the appended claims.

1-13. (canceled)

14. A method for the detection of CO in a hydrogen-rich gas stream, comprising:
feeding said gas stream past an electrochemical sensor;
measuring current through said electrochemical cell at an applied potential whereupon no oxidation of CO will take place, whilst oxidation of hydrogen is possible; and
determining therefrom the CO concentration, wherein the hydrogen-rich gas stream is fed only past the anode of said sensor, and the cathode of said sensor is wetted with water by placing it in a water reservoir.

15. The method according to claim 14, wherein said cathode is placed in the reservoir such that it forms the bottom of said reservoir.

16. The method according to claim 14, wherein determination of the CO concentration from the current comprises determining a decrease in the current.

17. The method according to claim 14, comprising brief application of a second, higher potential in order to oxidize the CO present on the anode.

18. The method according to claim 14, wherein the same catalyst material is used for said anode and cathode.

19. The method according to claim 14, wherein the inlet and the outlet of the sensor for the hydrogen-rich gas stream to be measured are connected to the anode only.

20. A device for the detection of CO in a hydrogen-rich gas stream comprising:
an electrochemical cell with anode, plastic membrane and cathode, said electrochemical cell provided with an inlet for gas and an outlet for gas; and
control means connected to said anode and cathode and designed to remove CO from the anode, wherein:
said cathode is provided with a water supply;
said gas inlet and gas outlet are connected to said anode only; and
said water supply provides direct contact of liquid water and said cathode.

21. The device according to claim 20, wherein said water supply comprises a reservoir, the bottom of said reservoir being said cathode.

22. The device according to claim 20, wherein said water supply comprises a water reservoir.

23. The device according to claim 20, wherein the cathode is provided with hydrogen gas discharge means.

24. The device according to claim 20, wherein the membrane is provided with a wetting zone for the gas flowing past the anode and a measurement zone for said gas located downstream of said wetting zone.

25. The device according to claim 20, wherein a path for the gas to be measured is delimited between the anode and the adjoining component facing away from the membrane.
